(19) United States
(12) Patent Application Publication
(10) Pub. No.: US 2026/0085708 A1
(43) Pub. Date: Mar. 26, 2026

(54) BLIND RIVET RETAINING CLIP FOR SOLAR MODULE

(71) Applicant: Nextracker LLC, Fremont, CA (US)

(72) Inventors: David Fred Bullock, Grants Pass, OR (US); Robert Bruce Wilcox, McGregor, TX (US)

(21) Appl. No.: 19/335,690

(22) Filed: Sep. 22, 2025

Related U.S. Application Data
(60) Provisional application No. 63/699,189, filed on Sep. 26, 2024.

(51) Int. Cl. F16B 2/22; F16B 19/10; H02S 20/32

(52) U.S. Cl. CPC F16B 2/22; F16B 19/1036; H02S 20/32; F16B 2200/93

(57) ABSTRACT

A blind rivet retaining clip includes a clip base, a blind rivet aperture, a grounding tab, and a blind rivet retention tab. The clip base is configured to interface with a first side of a solar module frame. The blind rivet aperture extends through the clip base. The grounding tab extends out from a first side surface of the clip base, and the blind rivet retention tab extends out from a second, opposite side surface of the clip base and adjacent to the blind rivet aperture. The blind rivet retention tab is configured to engage a blind rivet inserted through the blind rivet aperture. The grounding tab is configured to enable an electrical grounding function at the solar module frame when the blind rivet is inserted through the blind rivet aperture and when the blind rivet is set at the blind rivet aperture.

### RELATED APPLICATION

This application claims the benefit of U.S. Provisional Patent Application No. 63/699,189, filed Sep. 26, 2024, the entire contents of which are incorporated herein by reference.

### TECHNICAL FIELD

This disclosure relates generally to device, system, and method embodiments for coupling one or more solar module frames to a solar tracker using a blind rivet retaining clip.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor for many fastening connections to ultimately secure the solar modules to the torque tube of the solar tracker. As such, the installation of solar modules for current solar tracking systems can add significant cost to a solar tracking system application.

### SUMMARY

This disclosure in general describes device, system, and method embodiments relating to blind rivet retaining clips and coupling one or more solar module frames to a rail component and/or torque tube component of a solar tracker using one or more blind rivet retaining clip embodiments disclosed herein.

The following disclosure will describe various embodiments relating to blind rivet retaining clips which can be used, for instance, at a solar tracker to couple one or more solar module frames to a rail component which couples to a torque tube of a solar tracker. Such embodiments disclosed herein can be useful in facilitating more labor-efficient solar module frame installation at a solar tracker apparatus by helping to reduce the number of active component connections needed during installation and/or helping to increase the efficiency associated with coupling a solar module frame to a rail component of a solar tracker. For instance, embodiments disclosed herein can reduce a number of connection points, such as between a solar module frame and a rail, while also reducing the time and effort needed to set the coupling between the solar module frame and the rail component using one or more blind rivet retaining clips. For instance, because blind rivet retaining clip embodiments disclosed herein can be configured to engage a blind rivet inserted at the blind rivet retaining clip before the blind rivet is set at the blind rivet retaining clip, such blind rivet retaining clip embodiments disclosed herein can retain the blind rivet before it is set at the blind rivet retaining clip to thereby enable solar module frame alignment relative to the rail component and/or torque tube followed then, when the solar module frame is aligned with the rail component, by setting the blind rivet retained at the blind rivet retaining clip to thereby couple the solar module frame to the rail component. These embodiments can thus be useful in increasing the cost efficiency associated with installing a solar tracker system in the field as the time and labor needed can be reduced. For example, such embodiments disclosed herein can enable robotic installation (e.g., coupling) of a solar module at a rail component of a solar tracker using one or more blind rivet retaining clips along a robotic work axis while also reducing a number of connection points.

One embodiment includes a blind rivet retaining clip. This blind rivet retaining clip embodiment includes a clip base, a blind rivet aperture, a grounding tab, and a blind rivet retention tab. The clip base is configured to interface with a first side of a solar module frame. The blind rivet aperture extends through the clip base. The grounding tab extends out from a first side surface of the clip base. The blind rivet retention tab extends out from a second side surface of the clip base and adjacent to the blind rivet aperture, with the second side surface being opposite the first side surface. The blind rivet retention tab is configured to engage a blind rivet inserted through the blind rivet aperture. The grounding tab is configured to enable an electrical grounding function at the solar module frame when the blind rivet is inserted through the blind rivet aperture and when the blind rivet is set at the blind rivet aperture.

In a further embodiment of this clip, the grounding tab is configured to penetrate an anodizing layer at the solar module frame to enable the electrical grounding function as a result of the blind rivet being set at the blind rivet aperture.

In a further embodiment of this clip, the blind rivet retention tab is configured to engage the blind rivet inserted through the blind rivet aperture at a location at the blind rivet above the second side surface of the clip base. For example, the blind rivet retention tab can extend out from the second side surface of the clip base, to the location at the blind rivet above the second side surface of the clip base, at a skewed angle relative to the second side surface of the clip base.

In a further embodiment of this clip, the blind rivet retention tab can be configured to move away from the second side surface of the clip base when the blind rivet retention tab engages the blind rivet as the blind rivet is inserted through the blind rivet aperture, and the blind rivet retention tab can be configured to move toward the second side surface of the clip base when the blind rivet is set at the blind rivet aperture. For example, the clip base can be a planar surface that is configured to provide a resistive force against the blind rivet to cause the blind rivet to from a blind rivet bulb against the planar surface and about the blind rivet aperture at the second side surface of the clip base when the blind rivet is set at the blind rivet aperture. In one more particular such example, the blind rivet retention tab can be a first blind rivet retention tab, and the clip can further include a second blind rivet retention tab extending out from the second side surface of the clip base and adjacent to the blind rivet aperture, with the second blind rivet retention tab spaced apart from the first blind rivet retention tab about the second side surface of the clip base. This second blind rivet retention tab can be configured to move away from the second side surface of the clip base when the second blind rivet retention tab engages the blind rivet as the blind rivet is inserted through the blind rivet aperture, and this second blind rivet retention tab can be configured to move toward the second side surface of the clip base when the blind rivet is set at the blind rivet aperture.

In a further embodiment of this clip, the clip further includes: an alignment tab adjacent to the blind rivet aperture, and the alignment tab is configured to engage a coupling slot at the solar module frame. For example, the alignment tab can extend out from the first side surface of the clip base in a direction away from the blind rivet aperture.

In a further embodiment of this clip, the clip further includes: a mounting arm integral with the clip base. This mounting arm can be spaced apart from the clip base to define a solar module receptacle between the clip base and a first mounting arm surface of the mounting arm. The mounting arm can define a second blind rivet aperture in axial alignment with the blind rivet aperture at the clip base. In a yet further embodiment of such clip, the clip can additionally include a rail alignment tab adjacent to the second blind rivet aperture and extending out from a second mounting arm surface of the mounting arm. The second mounting arm surface can be opposite the first mounting arm surface, and the rail alignment tab can be configured to engage a coupling slot at a rail component.

Another embodiment includes a method (e.g., for installing at least one solar module at a solar tracker, such as at a rail component of a solar tracker which is attached to a rotatable torque tube of the solar tracker). This method embodiment includes the step of: placing a blind rivet at a blind rivet aperture at a blind rivet retaining clip such that a blind rivet retention tab of the blind rivet retaining clip engages the blind rivet. The blind rivet retaining clip includes: a clip base interfacing with a solar module frame, the blind rivet aperture extending through the clip base, a grounding tab extending out from a first side surface of the clip base to interface with the solar module frame, and the blind rivet retention tab extending out from a second, opposite side surface of the clip base and adjacent to the blind rivet aperture. This method embodiment also includes the step of: setting the blind rivet at the blind rivet retaining clip to form a rivet bulb at the blind rivet against the second side surface of the clip base.

In a further embodiment of this method, the method additionally includes:
establishing an electrical grounding connection between the solar module frame and the grounding tab at the blind rivet retaining clip as a result of setting the blind rivet at the blind rivet retaining clip. For example, setting the blind rivet at the blind rivet retaining clip to form the rivet bulb at the blind rivet against the second side surface of the clip base can cause the grounding tab at the blind rivet retaining clip to penetrate an anodizing layer at the solar module frame to establish the electrical grounding connection between the solar module frame and the grounding tab.

In a further embodiment of this method, the method additionally includes: when the blind rivet is placed at the blind rivet aperture at the blind rivet retaining clip such that the blind rivet retention tab engages the blind rivet and prior to setting the blind rivet, moving the solar module frame relative to a rail component with the blind rivet retention tab engaged at the blind rivet. For example, moving the solar module frame relative to the rail component with the blind rivet retention tab engaged at the blind rivet can include causing an alignment tab, which is adjacent to the blind rivet aperture, at the blind rivet retaining clip to engage a coupling slot at the solar module frame. And, when the alignment tab is engaged at the coupling slot at the solar module frame, the blind rivet is set at the blind rivet retaining clip to form the rivet bulb at the blind rivet against the second side surface of the clip base.

In a further embodiment of this method, placing the blind rivet at the blind rivet aperture such that the blind rivet retention tab engages at the blind rivet can include moving the blind rivet retention tab away from the second side surface of the clip base as the blind rivet is inserted through the blind rivet aperture. In addition, setting the blind rivet at the blind rivet retaining clip to form the rivet bulb at the blind rivet against the second side surface of the clip base can include moving the blind rivet retention tab toward the second side surface of the clip base. For example, setting the blind rivet at the blind rivet retaining clip to form the rivet bulb at the blind rivet against the second side surface of the clip base can include: applying a blind rivet setting force in a first direction along a first setting axis to cause application of a resistive force, via a planar surface at the second side surface of the clip base, in second, opposite direction along the first setting axis against the blind rivet to cause the blind rivet to from the blind rivet bulb against the planar surface and about the blind rivet aperture at the second side surface of the clip base and to cause a mandrel to break off of the blind rivet.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a schematic, perspective view of an embodiment of a solar tracker apparatus.

FIGS. 2A-2C illustrate an embodiment of a blind rivet retaining clip. FIG. 2A is a perspective view, FIG. 2B is a first side elevational view, and FIG. 2C is a second side (e.g., ninety degrees from the first side) elevational view of the embodiment of the blind rivet retaining clip.

FIGS. 3A-3C illustrate another embodiment of a blind rivet retaining clip. FIG. 3A is a perspective view, FIG. 3B is a first side elevational view, and FIG. 3C is a second side (e.g., ninety degrees from the first side) elevational view of the embodiment of the blind rivet retaining clip.

FIGS. 4A-4E illustrate an additional embodiment of a blind rivet retaining clip. FIG. 4A is a perspective view of the blind rivet retaining clip, FIG. 4B is an exploded, perspective view of the blind rivet retaining clip of FIG. 4A and a blind rivet relative to a solar module frame and rail component of solar tracker. FIGS. 4C-4E illustrate an exemplary sequence of placing a blind rivet at the blind rivet retaining clip (FIGS. 4C, 4D) and then setting the blind rivet at the blind rivet retaining clip (FIG. 4E).

FIG. 5 is a flow diagram of an embodiment of a method (e.g., for installing at least one solar module at a solar tracker, such as at a rail component of a solar tracker which is attached to a rotatable torque tube of the solar tracker).

FIGS. 6A-6E illustrate an exemplary sequence for executing a method, such as the method of FIG. 5, using the blind rivet retaining clip embodiment of FIGS. 3A-3C. FIGS. 6A and 6B illustrate perspective views of blind rivet retaining clip, of FIGS. 3A-3C, placed relative to a solar module frame, FIG. 6C is a perspective view of a blind rivet being placed at the blind rivet retaining clip of FIGS. 3A-3C to engage the blind rivet with a pair of blind rivet retention tabs, FIG. 6D is a perspective view of the pair of blind rivet retention tabs engaging the blind rivet and moved away from a clip base, and FIG. 6E is a perspective view of the blind rivet being set to form a rivet bulb against the clip base and to move the pair of blind rivet retention tabs toward the clip base.

FIG. 7 is a perspective view of another embodiment of a blind rivet retaining clip.

FIGS. 8A-8G illustrate an additional embodiment of a blind rivet retaining clip. FIG. 8A is a perspective view of this embodiment of the blind rivet retaining clip, FIG. 8B is an exploded, assembly view of the blind rivet retaining clip of FIG. 8A and a blind rivet relative to a solar module frame and rail component of solar tracker, FIGS. 8C and 8D illustrate perspective views of the blind rivet retaining clip of FIG. 8A placed relative to a solar module frame, FIG. 8E is a cross-sectional view of a blind rivet being placed at the blind rivet retaining clip to engage the blind rivet with a pair of blind rivet retention tabs, FIG. 8F is a cross-sectional view of the pair of blind rivet retention tabs engaging the blind rivet and moved away from a clip base, and FIG. 8G is a cross-sectional view of the blind rivet being set to form a rivet bulb against the clip base and to move the pair of blind rivet retention tabs toward the clip base.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

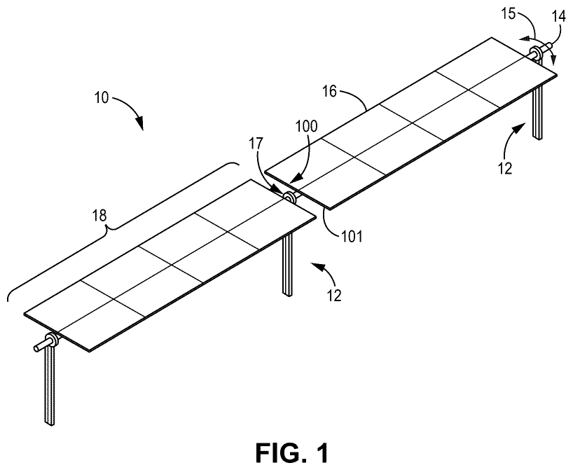

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and can be rotatably supported at each pier 12. The solar tracker apparatus 10 can further include a plurality of solar modules 16 (e.g., solar panels having photovoltaic cells 19, such as a photovoltaic laminate with a plurality of photovoltaic cells, at a frame) supported at the torque tube 14. The one or more torque tubes 14 can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 can be referred to as a bay 18 and, for example, in certain applications may be generally in the range of about 8 meters in length and each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame 100 that is coupled to the torque tube 14. As will be described herein, the solar module frame 100 can be coupled to the torque tube 14, using one or more blind rivet retaining clips, via a rail component which rail component itself couples to the torque tube 14. As will also be described herein for various embodiments, adjacent pairs solar module frames 100 of adjacent pairs of solar modules 16 can be coupled together to the torque tube 14, for instance, via one or more blind rivet retaining clips at a common rail component. Such blind rivet retaining clip can include a clip base that is configured to interface with a first side 101 of the solar module frame 100, which first side as shown at the example of FIG. 1 is facing upward away from the ground surface and visible at the rotational orientation of the torque tube at the example of FIG. 1. Frame 100 can also have a second, opposite side 102 facing downward toward the ground surface and not visible at the rotational orientation of the torque tube at the example of FIG. 1.

The following disclosure will describe various embodiments relating a blind rivet retaining clip which can be used, for instance, at a solar tracker to couple one or more solar module frames to a rail component which couples to a torque tube of a solar tracker. Such embodiments disclosed herein can be useful in facilitating more labor-efficient solar module frame installation at a solar tracker apparatus by helping to reduce the number of active component connections needed during installation and/or helping to increase the efficiency associated with coupling a solar module frame to a rail component of a solar tracker. For instance, embodiments disclosed herein can reduce a number of connection points, such as between a solar module frame and a rail, while also reducing the time and effort needed to set the coupling between the solar module frame and the rail component using one or more blind rivet retaining clips. Moreover, because blind rivet retaining clip embodiments can be configured to engage a blind rivet inserted at the blind rivet retaining clip before the blind rivet is set at the blind rivet retaining clip, such blind rivet retaining clip embodiments disclosed herein can retain the blind rivet before it is set at the blind rivet retaining clip so as to enable solar module frame alignment relative to the rail component and/or torque tube followed then by setting the blind rivet retained at the blind rivet retaining clip to thereby couple the solar module frame to the rail component when the solar module frame is aligned with the rail component. These embodiments can thus be useful in increasing the cost efficiency associated with installing a solar tracker system in the field as the time and labor needed can be reduced. For example, such embodiments disclosed herein can enable robotic installation (e.g., coupling) of a solar module at a rail component of a solar tracker using one or more blind rivet retaining clips along a robotic work axis while also reducing a number of connection points.

Thus, blind rivet retaining clip embodiments disclosed herein can be configured to facilitate more efficient and effective coupling installation of one or more solar module frames to a support structure, such as a rail component that is at a torque tube of a solar tracker. Namely, in such an example, blind rivet retaining clip embodiments disclosed herein can be configured to facilitate more efficient and effective installation of one or more solar module frames to a torque tube, such as in solar tracker applications, for instance, such as that shown at the example of FIG. 1. Such blind rivet retaining clip embodiments will be discussed as follows in conjunction with the accompanying drawing figures.

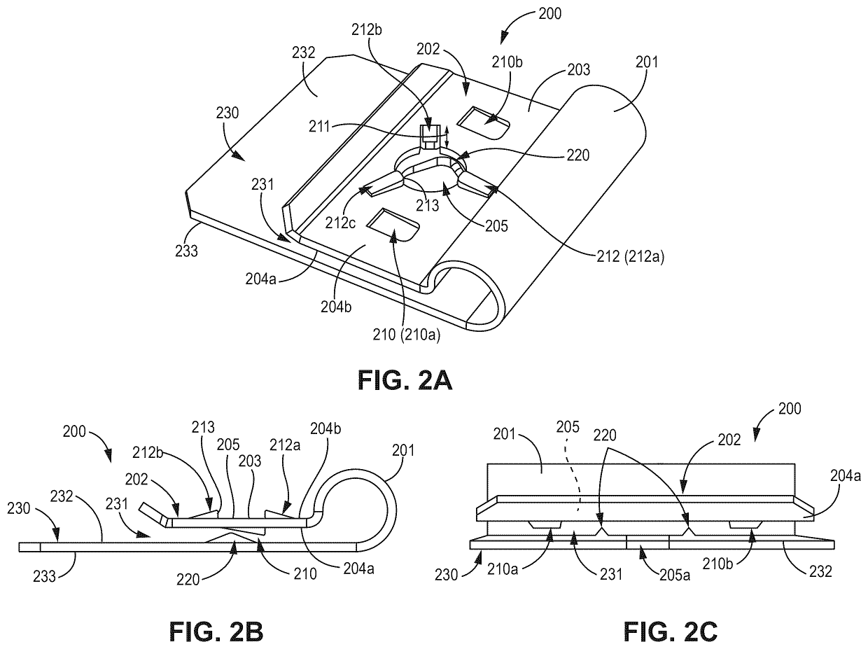

FIGS. 2A-2C illustrate an embodiment of a blind rivet retaining clip 200. FIG. 2A is a perspective view, FIG. 2B is a first side elevational view, and FIG. 2C is a second side (e.g., ninety degrees from the first side) elevational view of the embodiment of the blind rivet retaining clip 200. The blind rivet retaining clip 200 can be configured to couple at least one solar module frame to a torque tube of a solar tracker, for instance, by coupling the at least one solar module frame to a rail component at the torque tube via the blind rivet retaining clip 200.

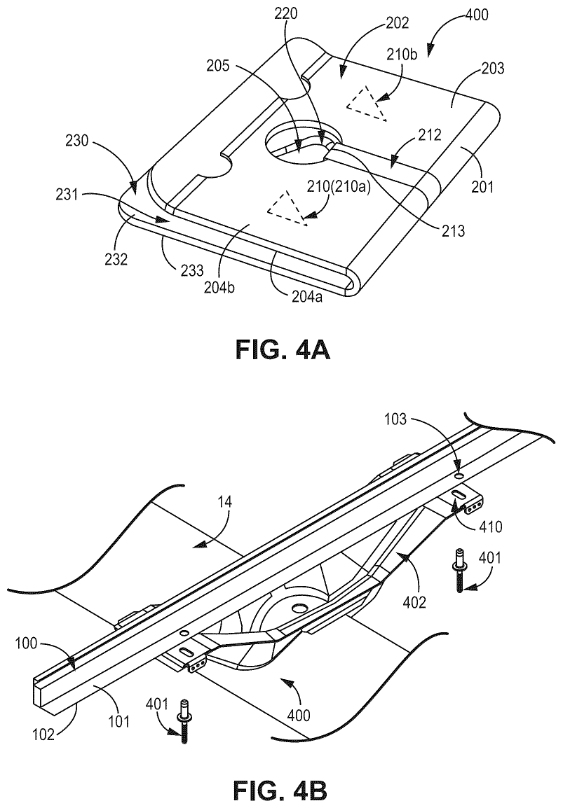

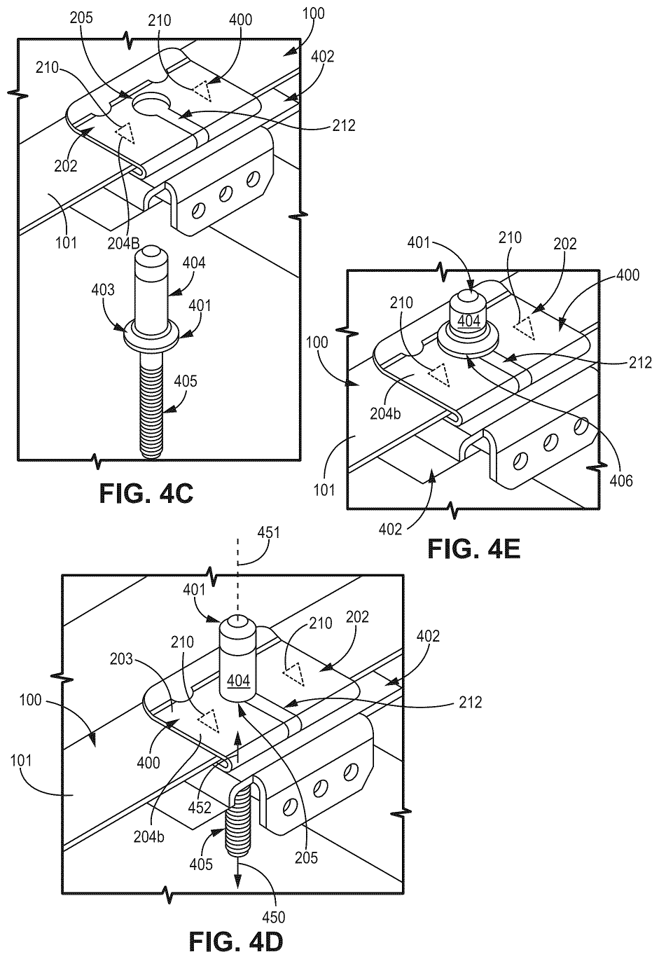

The blind rivet retaining clip 200 can have a clip body 201, and the clip body 201 can include a clip base 202. The clip base 202 can have a first side surface 204a at the clip base 202 and a second side surface 204b at the clip base, with the second side surface 204b being opposite the first side surface 204a. The clip base 202 can be configured to interface with a first side of a solar module frame (e.g., clip base 202 can be configured to interface with first side 101 of solar module frame 100 as shown at the illustrated example at FIG. 4B). The clip base 202 can define a planar surface 203. For such examples, this planar surface 203 can be configured to provide a resistive force against a blind rivet placed, at the blind rivet retaining clip 200, to cause this blind rivet to form a rivet bulb against the planar surface 203 when this blind rivet is set at the blind rivet retaining clip 200.

The blind rivet retaining clip 200 can further include a blind rivet aperture 205. The blind rivet aperture 205 can extend through the clip base 202. For embodiments where the clip base 202 includes the planar surface 203, the blind rivet aperture 205 can be defined at the planar surface 203. The blind rivet aperture 205 can be configured to receive a blind rivet thereat. For example, a blind rivet can be inserted through the blind rivet aperture 205 such that the blind rivet extends out from the blind rivet aperture 205 above the planar surface 203.

The blind rivet retaining clip 200 can additionally include one or more grounding tabs 210. The illustrated embodiment of the blind rivet retaining clip 200 is shown to include a pair of grounding tabs 210—first grounding tab 210a and second grounding tab 210b. Each of the one or more grounding tabs 210 can be included at the clip base 202. More specifically, each of the one or more grounding tabs 210 can extend out from first side surface 204a of the clip base 202, such as in a direction away from the clip base 202 (e.g., away from the second side surface 204b). Each of the one or more grounding tabs 210 can include a distal, free-floating end opposite the first side surface 204a from which it extends out, and this distal, free-floating end can define a projection or point thereat. Given the clip base 202 can be configured to interface with solar module frame, each of the one or more grounding tabs 210 extending out from the clip base 202 can be configured to interface with the solar module frame 100. And, each of the one or more grounding tabs 210 can be configured to enable an electrical grounding function at the solar module frame when the blind rivet is inserted through the blind rivet aperture 205 and when the blind rivet is set at the blind rivet aperture 205. For example, each of the one or more grounding tabs 210 can be configured to penetrate an anodizing layer at the solar module frame to enable the electrical grounding function as a result of the blind rivet being set at the blind rivet aperture 205. Namely, a setting force applied at the blind rivet, when the blind rivet is at the blind rivet aperture 205, can cause each of the one or more grounding tabs 210 to penetrate through an anodizing layer at the solar module frame as a result of application the setting force at the blind rivet and, thus, as a result of the blind rivet being set at the blind rivet aperture 205.

The blind rivet retaining clip 200 can also include one or more blind rivet retention tabs 212. The illustrated embodiment of the blind rivet retaining clip 200 is shown to include three blind rivet retention tabs 212—first blind rivet retention tab 212a, second blind rivet retention tab 212b, and third blind rivet retention tab 212c. Each of the one or more blind rivet retention tabs 212 can be included at the clip base 202. More specifically, each of the one or more blind rivet retention tabs 212 can be included at, and extend out from, second side surface 204b of the clip base 202, such as in a direction away from the clip base 202 (e.g., away from the first side surface 204a). And, each of the one or more blind rivet retention tabs 212 can be included at, and extend out from, second side surface 204b adjacent to the blind rivet aperture 205. For example, as shown for the illustrated embodiment here, each of the first, second, and third blind rivet retention tabs 212a, 212b, 212c can be adjacent to the blind rivet aperture 205 at the second side surface 204b of the clip base 202 and spaced apart from one another circumferentially about the blind rivet aperture 205 at the second side surface 204b.

Each of the one or more blind rivet retention tabs 212 can be configured to engage a blind rivet as the blind rivet is inserted through the blind rivet aperture 205, such as the blind rivet is inserted through the blind rivet aperture 205 in a direction from the first side surface 204a toward the second side surface 204b. For example, each of the one or more blind rivet retention tabs 212 can include a distal, free-floating engagement end portion 213 opposite the second side surface 204b from which the blind rivet retention tab 212 can extend out, and this distal, free-floating engagement end portion 213 can define a blind rivet engagement surface thereat for engaging with a blind rivet inserted through the blind rivet aperture 205. This engagement end portion 213 at each of the one or more blind rivet retention tabs 212 can be adjacent to the blind rivet aperture 205 such that as the blind rivet is inserted through the blind rivet aperture 205, the engagement end portion 213 at each of the one or more blind rivet retention tabs 212 can engage with the blind rivet as the blind rivet is inserted through the blind rivet aperture 205 and above the second side surface 204b. The engagement end portion 213 at each of the one or more blind rivet retention tabs 212 can include a tab engagement structure complementary to a structure at the blind rivet to facilitate engagement between the tab engagement structure at the engagement end portion 213 at the complementary structure at the blind rivet inserted though the blind rivet aperture 205. Thus, each of the one or more the blind rivet retention tabs 212 can be configured to engage the blind rivet inserted through the blind rivet aperture 205 at a location at the blind rivet above the second side surface 204b of the clip base 202. For instance, each of the one or more blind rivet retention tabs 212 can extend out from the second side surface 204b of the clip base 202, to the location at the blind rivet above the second side surface 204b of the clip base 202, at a skewed angle, such as at an angle ranging from one to seventy five degrees, relative to the second side surface 204b of the clip base 202.

Each of the one or more blind rivet retention tabs 212 can be movable relative to the clip base 202. For example, each of the one or more blind rivet retention tabs 212 can be movable relative to the clip base (e.g., relative to the second side surface 204b of the clip base 202) between a stowed position and a blind rivet engagement position, such as, for instance, in directions 211. FIGS. 2A-2C shows the blind rivet retention tabs 212 at one exemplary blind rivet engagement position. Each of the one or more blind rivet retention tabs 212 can be at the stowed position prior to the blind rivet being inserted through the blind rivet aperture 205, and each of the one or more blind rivet retention tabs 212 can be at the blind rivet engagement position when the blind rivet is inserted through the blind rivet aperture 205. Thus, inserting the blind rivet through the blind rivet aperture 205 can cause each of the one or more blind rivet retention tabs 212 to move from the stowed position to the blind rivet engagement position.

At the stowed position, the engagement end portion 213 at each of the one or more blind rivet retention tabs 212 can be closer to the second side surface 204b of the clip base 202 than the engagement end portion 213 at each of the one or more blind rivet retention tabs 212 when the respective blind rivet retention tab is at the blind rivet engagement position. As one example, when at the stowed position, each of the one or more blind rivet retention tabs 212 can be generally flush with the second side surface 204b such that the respective engagement end portions 213 can lie in a common elevational plane with the second side surface 204b. At the blind rivet engagement position, the engagement end portion 213 at each of the one or more blind rivet retention tabs 212 can be further from the second side surface 204b of the clip base 202 than the engagement end portion 213 at each of the one or more blind rivet retention tabs 212 is when at the stowed position. As one example, when at the blind rivet engagement position, the engagement end portion 213 at each of the one or more blind rivet retention tabs 212 can be raised up above the second side surface 204b to move the engagement end portion 213 out of a common elevational plane with the second side surface 204b and to change the orientation of at least the engagement end portion 213 from being generally flush with the second side surface 204b, at the stowed position, to the skewed angle between the engagement end portion 213 and the second side surface 204b.

Thus, each of the one or more blind rivet retention tabs 212 can be configured to move away from the second side surface 204b of the clip base 202 when the blind rivet retention tab 212 engages the blind rivet as the blind rivet is inserted through the blind rivet aperture 205 (e.g., to transition the engagement end portion 213 at each of the one or more blind rivet retention tabs 212 from the stowed position to the blind rivet engagement position). In addition, as will be shown and described elsewhere herein, the blind rivet retention tab 212 can be configured to move toward the second side surface 204b of the clip base 202 when the blind rivet is set at the blind rivet aperture 205. As will also be detailed further herein, the blind rivet retention tab 212 can be configured to engage the blind rivet inserted through the blind rivet aperture to thereby help to retain the blind rivet at the blind rivet aperture 205 via engagement between the blind rivet and the engagement end position 213 prior to setting the blind rivet at the blind rivet aperture 205 (e.g., prior to forming a blind rivet bulb at the blind rivet against the clip base 202). This can be useful in increasing the efficiency of solar module frame installation at a solar tracker by enabling alignment and movement between the solar module frame, rail component, and blind rivet retaining clip 200 while the blind rivet is retained at the blind rivet retaining clip 200 and prior to setting the blind rivet at the blind rivet aperture 205.

For some embodiments, the blind rivet retaining clip 200 can further include one or more alignment tabs 220. The illustrated embodiment includes a pair of alignment tabs 220 spaced apart from another. In particular, each of the one or more alignment tabs 220 can be adjacent to the blind rivet aperture 205, such as axially adjacent the blind rivet aperture 205 but elevational offset along such axis from the blind rivet aperture 205. Each of the one or more alignment tabs 220 can extend out either from the first side surface 204a of the clip base 202 in a direction away from the blind rivet aperture 205 or extend out from a mounting arm 230 below the clip base 202 in a direction upward from the mounting arm 230 toward the blind rivet aperture 205. Each of the one or more alignment tabs 220 can be configured to engage a coupling slot at the solar module frame to thereby help to align the blind rivet retaining clip 200 with the coupling slot at the solar module frame which is to be aligned with the blind rivet aperture 205. Thus, each of the one or more alignment tabs 220 can be configured to provide tactile feedback indicating alignment between the blind rivet aperture 205 at the blind rivet retaining clip 200 and the coupling slot at the solar module frame so that the blind rivet can be inserted axially through the coupling slot at the solar module frame and the blind rivet aperture 205 at the blind rivet retaining clip 200.

As noted, the illustrated embodiment of the blind rivet retaining clip 200 can include the mounting arm 230. The mounting arm 230 can be integral with the clip base 202. The mounting arm 230 can be spaced apart from the clip base 202 to define a solar module receptacle 231 between the clip base 202 and a first mounting arm surface 232 of the mounting arm 230. The mounting arm 230 can define a second blind rivet aperture 205a in axial alignment with the blind rivet aperture 205, such as seen at the example of FIG. 2C, and the blind rivet can be inserted through the second blind rivet aperture 205a in addition to being inserted through the blind rivet aperture 205 at the clip base 202 (e.g., the blind rivet is inserted through the second blind rivet aperture 205a before the blind rivet is inserted through the blind rivet aperture 205 at the clip base 202).

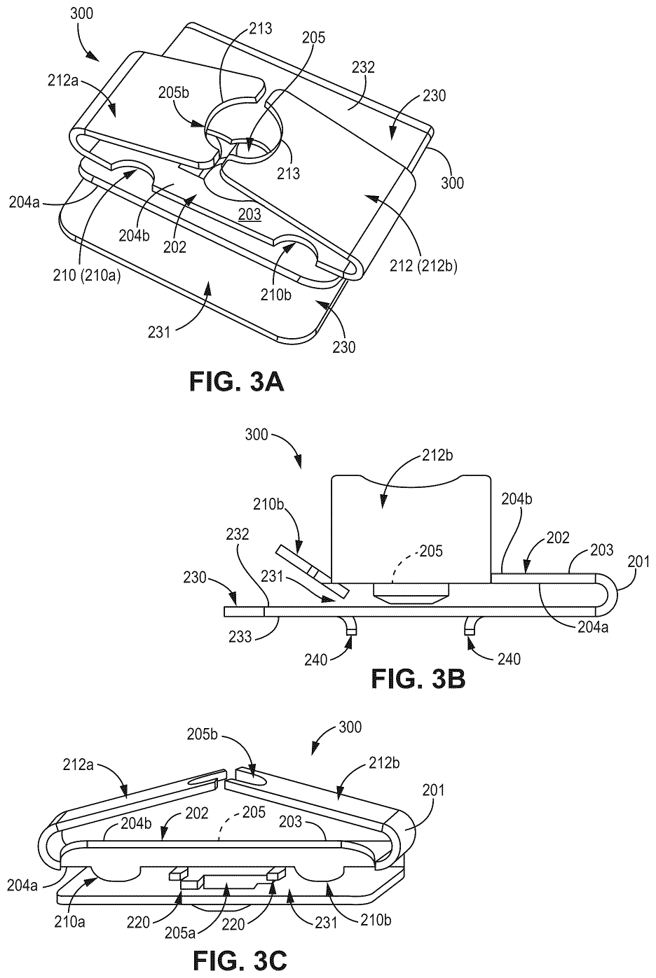

FIGS. 3A-3C illustrate another embodiment of a blind rivet retaining clip 300. FIG. 3A is a perspective view, FIG. 3B is a first side elevational view, and FIG. 3C is a second side (e.g., ninety degrees from the first side) elevational view of the embodiment of the blind rivet retaining clip 300. The blind rivet retaining clip 300 can be similar to, or the same as, the blind rivet retaining clip 200 disclosed previously and, thus, like reference characters represent like elements.

As with the blind rivet retaining clip 200, the blind rivet retaining clip 300 can include the clip base 202, the blind rivet aperture 205, the one or more grounding tabs 210, and the one or more blind rivet retention tabs 212 as disclosed previously herein with respect to the blind rivet retaining clip 200. The illustrated embodiment of the blind rivet retaining clip 300 can also include the one or more alignment tabs 220, for instance, as with the previous embodiment of the blind rivet retaining clip 200.

The blind rivet retention tabs 212 of the blind rivet retaining clip 300 can be movable relative to the clip base 202 between the stowed and blind rivet engagement positions as described previously. The blind rivet retention tabs 212 shown for the blind rivet retaining clip 300 embodiment can be a pair of blind rivet retention tabs 212a, 212b, and for the blind rivet retaining clip 300 embodiment shown here the distal, free-floating engagement end portion 213 can define at least a portion of a retention tab blind rivet aperture 205b. For instance, together the first and second blind rivet retention tabs 212a, 212b can define retention tab blind rivet aperture 205b via the engagement end portion 213 at each of the first and second blind rivet retention tabs 212a, 212b. The illustrated embodiment shows the engagement end portion 213 at each of the first and second blind rivet retention tabs 212a, 212b defining a generally semi-circular portion of the retention tab blind rivet aperture 205b. The blind rivet retention tabs 212 for the blind rivet retaining clip 300 embodiment shown here can engagement the blind rivet inserted through the blind rivet aperture 205 at the retention tab blind rivet aperture 205b defined by the engagement end portions 213 to retain the blind rivet at the blind rivet retaining clip 300 prior to setting the blind rivet at the blind rivet retaining clip 300.

The illustrated embodiment of the blind rivet retention clip 300 can further include one or more rail alignment tabs 240. Each of the one or more rail alignment tabs 240 can be adjacent to the second blind rivet aperture 205a, and each of the one or more rail alignment tabs 240 can extend out from a second mounting arm surface 233 of the mounting arm 230 opposite the first mounting arm surface 232 of the mounting arm 230. Each of the one or more rail alignment tabs 240 can be configured to engage a coupling slot at a rail component to thereby help align the blind rivet retention clip relative to the coupling slot at the rail component. Thus, each of the one or more rail alignment tabs 240 can be configured to provide tactile feedback indicating alignment between the second blind rivet aperture 205a at the mounting arm 230 of the blind rivet retention clip 300 and the coupling slot at the rail component so that the blind rivet can be inserted axially through the coupling slot at the rail component, the second blind rivet aperture 205a at the mounting arm 230, and the blind rivet aperture 205 at the clip base 202.

FIGS. 4A-4E illustrate an additional embodiment of a blind rivet retaining clip 400. FIG. 4A is a perspective view of the blind rivet retaining clip 400, an FIG. 4B is an exploded, perspective view of a pair of such blind rivet retaining clips 400 and corresponding pair of blind rivets 401 relative to solar module frame 100 and rail component 402 of a solar tracker, for example such as that disclosed with respect to FIG. 1. The blind rivet retaining clip 400 can be similar to, or the same as, the blind rivet retaining clips 200 and/or 300 disclosed previously and, thus, like reference characters represent like elements.

As with the blind rivet retaining clip 200, the blind rivet retaining clip 400 can include the clip base 202, the blind rivet aperture 205, the one or more grounding tabs 210, and blind rivet retention tab 212 as disclosed previously herein with respect to the blind rivet retaining clip 200. The illustrated embodiment of the blind rivet retaining clip 400 can also include the one or more alignment tabs 220, for instance, as with the previous embodiment of the blind rivet retaining clip 200. As previously described, blind rivet 401 can be placed through the blind rivet aperture 205 at the blind rivet retaining clip 400 to cause the blind rivet retention tab 212 to engage the blind rivet 401 (e.g., via the engagement end portion 213) as the blind rivet is inserted through the blind rivet aperture 205 to help retain the blind rivet 401 at the blind rivet retaining clip 400 prior to setting the blind rivet 401 at the blind rivet retaining clip 400. Then, with the blind rivet 401 retained at the blind rivet retention tab 212 at blind rivet retaining clip 400, the solar module frame 100, rail 402, and blind rivet retaining clip 400 can be axially aligned relative to one another and the blind rivet 401 can be set at the blind rivet retaining clip 400. Axially aligning the solar module frame 100, rail 402, and blind rivet retaining clip 400 can include axially aligning blind rivet aperture 205 with each of coupling slot 410 at rail 402 and coupling slot 103 at solar module frame 100 such that blind rivet 401 can be inserted through each of the axially aligned blind rivet aperture 205, rail coupling slot 410, and frame coupling slot 103. The ability to move the blind rivet retaining clip relative to each of the frame 100 and rail 402 while the blind rivet retaining clip retains the blind rivet 401 prior to setting the blind rivet 401 at the blind rivet retaining clip can allow for efficient such alignment followed by efficient coupling of the frame 101 to the rail 402 via setting the blind rivet 401 retained at the blind rivet retaining clip.

FIGS. 4C-4E illustrate an exemplary sequence of placing blind rivet 401 at the blind rivet retaining clip 400 (FIGS. 4C, 4D) and then setting the blind rivet 401 at the blind rivet retaining clip 400 (FIG. 4E). While the exemplary sequence at FIGS. 4C-4E shows the embodiment of the blind rivet retaining clip 400, the sequence at FIGS. 4C-4E can also likewise apply to other blind rivet retaining clip embodiments disclosed elsewhere herein, such as the blind rivet retaining clips 300, 400.

As seen at the example of FIGS. 4C and 4D, the blind rivet 401 can be placed at the blind rivet retaining clip 400. The blind rivet 401 can include a rivet flange 403, a rivet head 404 at one side of the rivet flange 403, and a rivet mandrel 405 at another, opposite side of the rivet flange 403. The blind rivet 401 can be placed at the blind rivet aperture 205 at the blind rivet retaining clip 400. Placing the blind rivet 401 at the blind rivet aperture 205 can cause blind rivet retention tab 212 to engages the blind rivet 401, such as at the rivet head 404. For example, the blind rivet 401 can be placed at the blind rivet aperture 205 such that the blind rivet retention tab 212 engages the blind rivet 401 prior to setting the blind rivet 401. Placing the blind rivet 401 at the blind rivet aperture 205 can cause the blind rivet retention tab 212 to engage at the blind rivet 401 to thereby move the blind rivet retention tab 212, along with the blind rivet 401 as it is inserted through the blind rivet aperture 205, away from the second side surface 204b of the clip base 202 as the blind rivet 401 is inserted through the blind rivet aperture 205. This can cause the blind rivet retention tab 212 to move from a stowed position, such as shown at FIG. 4C, to the blind rivet engagement position, such as shown at FIG. 4D, and, thus, can cause the blind rivet retention tab 212 to move from generally co-planar (e.g., flush) with the second side surface 204b, such as at the stowed position of FIG. 4C, to oriented above and skewed relative to the second side surface 204b, such as at the blind rivet engagement position of FIG. 4D.

With the blind rivet 401 retained at the blind rivet retaining clip 400 via the blind rivet retention tab 212, the blind rivet 401 can then be set at the blind rivet retaining clip 400 to form a rivet bulb 406 at the blind rivet 401 against the second side surface 204b of the clip base 202 such as shown at FIG. 4E. For example, as a result of so setting the blind rivet 401 at the blind rivet retaining clip 400, an electrical grounding connection can be established between the solar module frame 100 and the grounding tab 210 at the blind rivet retaining clip 400. In particular, setting the blind rivet 401 at the blind rivet retaining clip 400 to form the rivet bulb 406 at the blind rivet 401 against the second side surface 204b of the clip base 202 can cause the one or more grounding tabs 210 at the blind rivet retaining clip 400 to penetrate an anodizing layer at the first side 101 of the solar module frame 100 to establish the electrical grounding connection between the solar module frame 100 and the blind rivet retaining clip 400 via the grounding tab 210 at the blind rivet retaining clip 400. As illustrated at the example at FIG. 4E, setting the blind rivet 401 at the blind rivet retaining clip 400 to form the rivet bulb 406 at the blind rivet 401 against the second side surface 204b of the clip base 202 can include moving the blind rivet retention tab 212 toward the second side surface 204b of the clip base 202. For instance, setting the blind rivet 401 at the blind rivet retaining clip 400 to form the rivet bulb 406 against the second side surface 204b of the clip base 202 can cause the blind rivet retention tab 212 to move from the blind rivet engagement position (e.g., shown at FIG. 4D) back to the stowed position such as shown at FIG. 4E (and FIG. 4C prior to inserting the blind rivet 401). As one specific such example, setting the blind rivet 401 at the blind rivet retaining clip 400 to form the rivet bulb 406 at the blind rivet 401 against the second side surface 204b can include applying a blind rivet setting force 450 in a first direction along a first setting axis 451 to cause application of a resistive force 452, via planar surface 203 at the second side surface 204b of the clip base 202, in a second, opposite direction along the first setting axis 451 against the blind rivet 401 to cause the blind rivet 401 to from the blind rivet bulb 406 against the planar surface 203 and about the blind rivet aperture 205 at the second side surface 204b of the clip base 202 and to cause mandrel 405 to break off of the blind rivet 401 such that the mandrel 405 can be removed, as shown at FIG. 4E, when setting the blind rivet 401.

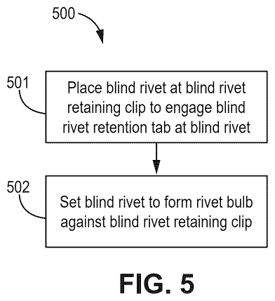

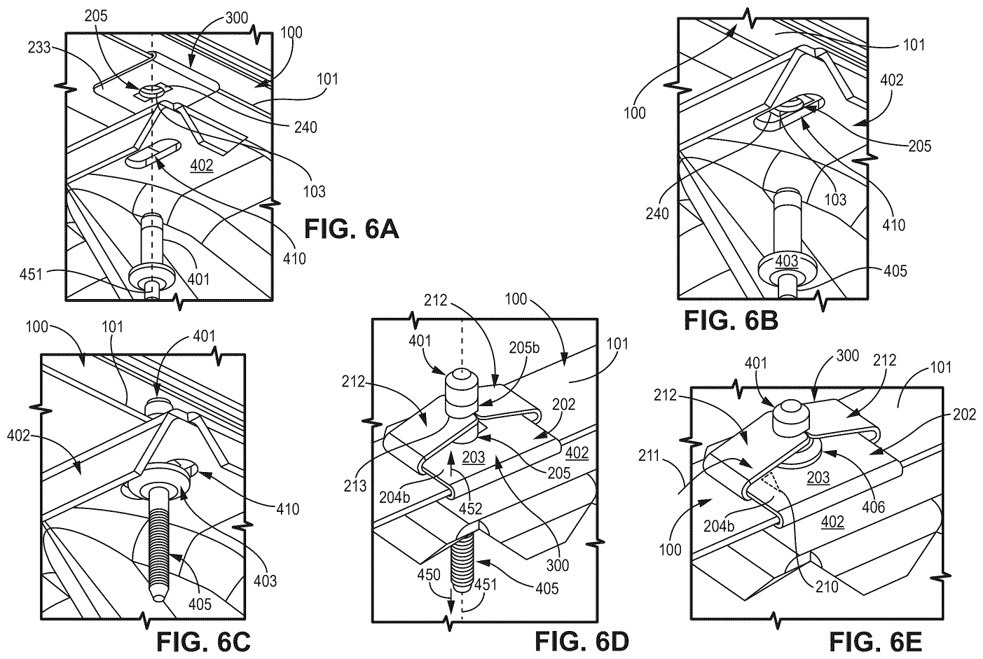

Further to the above discussion as to placing and setting a blind rivet at an embodiment of a blind rivet retaining clip, FIG. 5 is a flow diagram of an embodiment of a method 500. The method 500 can be executed, for example, to install at least one solar module frame at a solar tracker, such as at a rail component of a solar tracker which is attached to a rotatable torque tube of the solar tracker. In addition, FIGS. 6A-6E illustrate an exemplary sequence for executing a method, such as the method 500 of FIG. 5, using a blind rivet retaining clip embodiment, such as any one of those disclosed elsewhere herein. As such, FIGS. 6A-6E will be referenced with respect to the method 500 for the purposes of illustrating one exemplary application executing the method 500. Specifically, FIGS. 6A and 6B illustrate perspective views of blind rivet retaining clip 300 placed relative to solar module frame 100, FIG. 6C is a perspective view of blind rivet 401 being placed at the blind rivet retaining clip 300 to engage the blind rivet 401 with a pair of blind rivet retention tabs 212, FIG. 6D is a perspective view of the pair of blind rivet retention tabs 212 engaging the blind rivet 401 and moved away from clip base 202, and FIG. 6E is a perspective view of the blind rivet 401 being set to form rivet bulb 406 against the clip base 202 and to move the pair of blind rivet retention tabs 212 toward the clip base 202.

At step 501, the method 500 includes placing blind rivet 401 at blind rivet aperture 205 at a blind rivet retaining clip 300. For instance, as seen at FIGS. 6A-6D, the blind rivet 401 can be placed at the blind rivet aperture 205 such that blind rivet retention tab 212 of the blind rivet retaining clip 300 can engage the blind rivet 401. In some such examples, placing the blind rivet 401 at the blind rivet aperture 205 such that the blind rivet retention tab 212 engages at the blind rivet 401 can include moving the blind rivet retention tab 212 away from the second side surface 204b of the clip base 202 as the blind rivet 401 is inserted through the blind rivet aperture 205, for instance at seen at FIGS. 6C and 6D. Thus, in some embodiments, placing the blind rivet 401 at the blind rivet aperture 205 at the clip 300 can cause the blind rivet retention tab 212 to move from the stowed position to the blind rivet engagement position.

In addition, for some embodiments, at step 501, the blind rivet 401 can be placed at the blind rivet aperture 205 at the blind rivet retaining clip 300 such that the blind rivet 401 extends through each of blind rivet aperture 205, rail coupling slot 410, and frame coupling slot 103. For instance, when the blind rivet 401 is placed at the blind rivet aperture 205 such that the blind rivet retention tab 212 engages the blind rivet 401 prior to setting the blind rivet 401 at the clip 300, the solar module frame 100 can be moved relative to the rail component 402 while the blind rivet retention tab 212 engages at the blind rivet 401, such as shown at FIGS. 6C and 6D. The solar module frame 100 can be moved relative to the rail component 402 while the blind rivet retention tab 212 engages at the blind rivet 401 to create axial alignment, such as along axis 451, between blind rivet aperture 205, rail coupling slot 410, and frame coupling slot 103 while the blind rivet retention tab 212 engages and retains the blind rivet 401 at the clip 300. In some such examples, moving the solar module frame 100 relative to the rail component 402 with the blind rivet retention tab 212 engaged at the blind rivet 401 can include causing alignment tab(s) 220, which can be adjacent to the blind rivet aperture 205, at the blind rivet retaining clip 300 to engage at coupling slot 103 at solar module frame 100. (E.g., Then when the alignment tab 220 is engaged at the coupling slot 103 at the solar module frame 100, the blind rivet 401 can be set at the blind rivet retaining clip 300 to form the rivet bulb 406 at the blind rivet 401 against the second side surface 204b of the clip base 202.)

Furthermore, for some embodiments, at step 501, the blind rivet 401 can be placed at the blind rivet aperture 205 at the blind rivet retaining clip 300 such that an electrical grounding connection is established between the solar module frame 100 and the grounding tab(s) 210 at the blind rivet retaining clip 300. In some such examples, this electrical grounding connection can be established by placing the clip 300 at the frame 100 while in other examples this electrical grounding connection can be established as a result of setting the blind rivet at the blind rivet retaining clip at step 502.

At step 502, the method 500 includes setting the blind rivet 401 at the blind rivet retaining clip 300 to form rivet bulb 406 at the blind rivet 401 against the second side surface 204b of the clip base 202. For instance, as shown at the example at FIG. 6E, setting the blind rivet 401 at the blind rivet retaining clip 300 to form the rivet bulb 406 at the blind rivet 401 against the second side surface 204b of the clip base 202 can include moving the blind rivet retention tab 212 in the direction 211 toward the second side surface 204b of the clip base 202. As also shown at FIGS. 6D and 6E, for some embodiments, setting the blind rivet 401 at the blind rivet retaining clip 300 to form the rivet bulb 406 at the blind rivet 401 against the second side surface 204b of the clip base 202 can additionally include applying blind rivet setting force 450 in the direction 211 along setting axis 451 to cause application of resistive force 452, via planar surface 203 at the second side surface 204b of the clip base 202, in second direction that is opposite the direction 211 along the first setting axis 451 against the blind rivet 401 to cause the blind rivet 401 to from the blind rivet bulb 406 against the planar surface 203 and about the blind rivet aperture 205 at the second side surface 204b of the clip base 202 and to cause mandrel 405 to break off of the blind rivet 401 as a result of converting the counteracting applied forces 450, 452 into a mandrel breaking force.

As noted previously, for some embodiments, setting the blind rivet 401 at the blind rivet retaining clip 300 to form the rivet bulb 406 at the blind rivet 401 against the second side surface 204b of the clip base 202 can cause one or more grounding tabs 210 at the blind rivet retaining clip 300 to penetrate anodizing layer at the first side 101 of the solar module frame 100 to establish the electrical grounding connection between the solar module frame 100 and the grounding tab 210 at the clip 300.

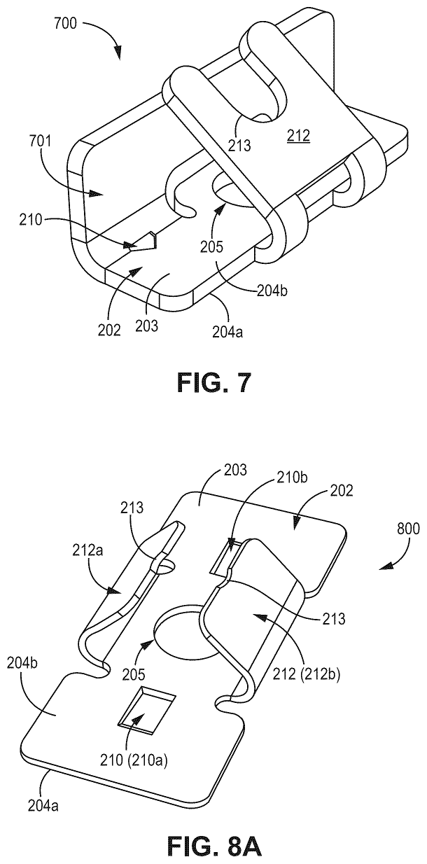

FIG. 7 is a perspective view of another embodiment of a blind rivet retaining clip 700. The blind rivet retaining clip 700 can be similar to, or the same as, the blind rivet retaining clips 200, 300, and/or 400 disclosed previously except as otherwise disclosed herein in reference to FIG. 7 and, thus, like reference characters represent like elements.

The blind rivet retaining clip 700 can include the clip base 202, the blind rivet aperture 205, one or more grounding tabs 210, and blind rivet retention tab 212, such as disclosed previously herein with respect to the blind rivet retaining clips 200, 300, 400. The clip 700 illustrated here can also include sidewall 701 which can project up from the clip base 202 in the same direction the blind rivet retention tab 212 projects up from the clip base 202. For example, as illustrated here, the sidewall 701 can project up from the clip base 202 at a perpendicular orientation with respect to the clip base 202, while the blind rivet retention tab 212 can project up from the clip base 202 at a skewed angle with respect to the clip base 202. The sidewall 701 can provide a contact interface structure against the solar module frame to provide further stability to the orientation of the clip relative to the frame. The one or more grounding tabs 210 can project down from the clip base 202, and thus out from the first side surface 204a of the clip base 202, in an opposite direction of the sidewall 701 and blind rivet retention tab 212.

As previously described, a blind rivet can be placed through the blind rivet aperture 205 at the blind rivet retaining clip 700 to cause the blind rivet retention tab 212 to engage the blind rivet (e.g., via the engagement end portion 213) as the blind rivet is inserted through the blind rivet aperture 205. Engaging the blind rivet placed at the blind rivet aperture 205 with the blind rivet retention tab 212 can help to retain the blind rivet at the blind rivet retaining clip 700 prior to setting the blind rivet at the blind rivet retaining clip 700 (e.g., to allow for moving solar module relative to rail prior to setting the blind rivet at the blind rivet retaining clip 700). Then, with the blind rivet retained at the blind rivet retention tab 212 at blind rivet retaining clip 700, the solar module frame, rail 402, and blind rivet retaining clip 400 can be coupled together by setting the blind rivet retained at the blind rivet retention tab 212 at the blind rivet retention clip 700 as described previously to form the rivet bulb against the clip base 202.

The blind rivet retaining clip 700 can exclude a mounting arm as described previously for other clip embodiments such that the clip base 202 of the blind rivet retaining clip 700 can be configured to sit at the first side of the solar module frame without a structure sitting below the opposite second side of the solar module frame. The blind rivet retaining clip 700 can exclude alignment tabs 220 as well such that the clip base 202 can move freely relative to the first side of the solar module frame, including moving freely over the coupling slot at that first side of the solar module frame.

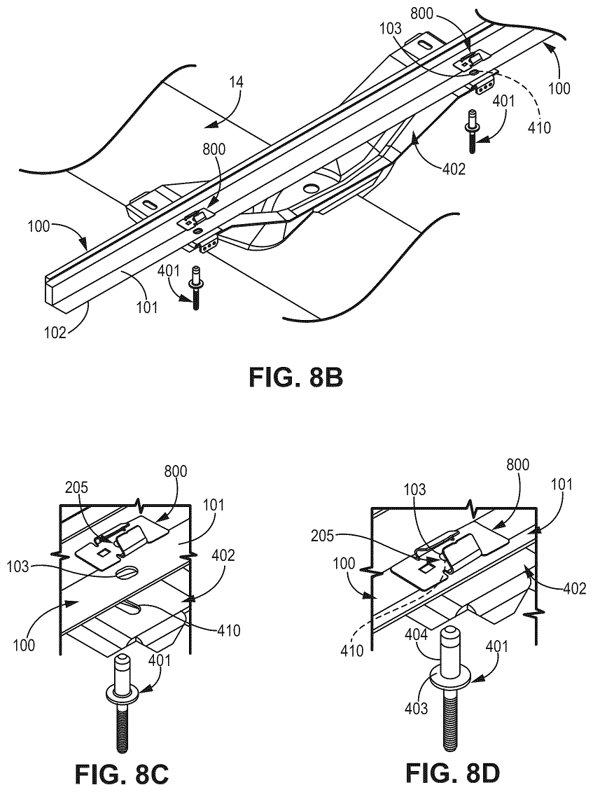

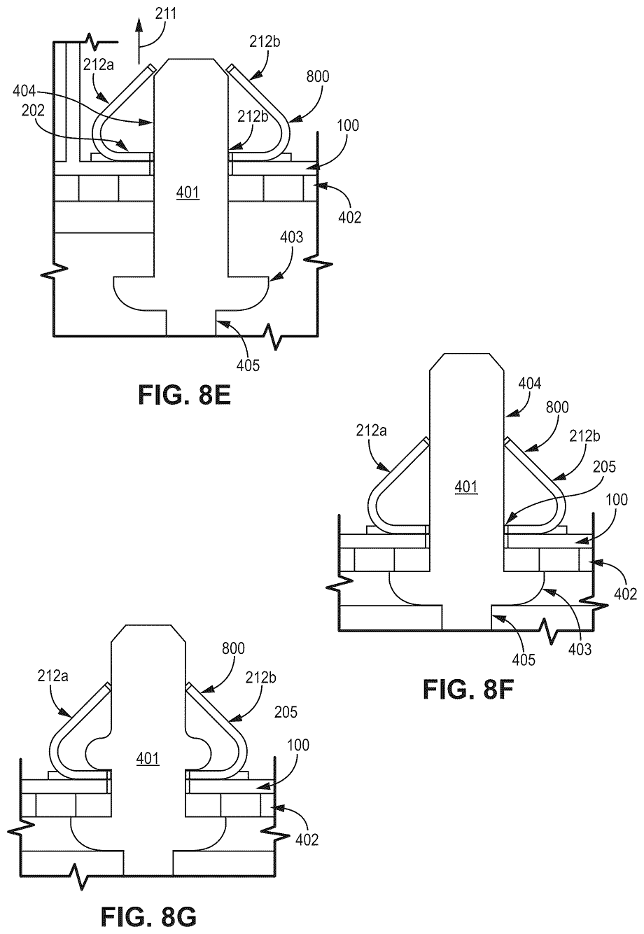

FIGS. 8A-8G illustrate an additional embodiment of a blind rivet retaining clip 800. The blind rivet retaining clip 800 can be similar to, or the same as, the blind rivet retaining clips 200, 300, 400, and/or 700 disclosed previously except as otherwise disclosed herein in reference to FIG. 8 and, thus, like reference characters represent like elements. FIG. 8A is a perspective view of this embodiment of the blind rivet retaining clip 800, FIG. 8B is an exploded, assembly view of the blind rivet retaining clip 800 and blind rivet relative 401 to solar module frame 100 and rail component 402 of a solar tracker, FIGS. 8C and 8D illustrate perspective views of the blind rivet retaining clip 800 placed relative to solar module frame 100, FIG. 8E is a cross-sectional view of blind rivet 401 being placed at the blind rivet retaining clip 800 to engage the blind rivet 401 with a pair of blind rivet retention tabs 212, FIG. 8F is a cross-sectional view of the pair of blind rivet retention tabs 212 engaging the blind rivet 401 and moved away from clip base 202, and FIG. 8G is a cross-sectional view of the blind rivet 401 being set to form rivet bulb 406 against the clip base 202 and to move the pair of blind rivet retention tabs 212 toward the clip base 202.

The blind rivet retaining clip 800 can include the clip base 202, the blind rivet aperture 205, one or more grounding tabs 210 (e.g., first and second ground tabs 210a, 210b at opposite sides of the blind rivet aperture 205), and a pair of blind rivet retention tabs 212 (e.g., first and second blind rivet retention tabs 212a, 212b), such as disclosed previously herein with respect to the blind rivet retaining clips 200, 300, 400. The one or more grounding tabs 210 can project down from the clip base 202, and thus out from the first side surface 204a of the clip base 202, in an opposite direction of each of the pair of blind rivet retention tabs 212.

As previously described, blind rivet 401 can be placed through the blind rivet aperture 205 at the blind rivet retaining clip 800 to cause the blind rivet retention tabs 212 to engage the blind rivet 401 (e.g., via the engagement end portion 213 at each retention tab 212) as the blind rivet 401 is inserted through the blind rivet aperture 205 at the clip 800. Engaging the blind rivet 401 placed at the blind rivet aperture 205 with the blind rivet retention tabs 212 can help to retain the blind rivet 401 at the blind rivet retaining clip 800 prior to setting the blind rivet at the blind rivet retaining clip 800 (e.g., to allow for moving solar module 100 relative to rail 402 to align coupling slots 103, 410 prior to setting the blind rivet 401 at the blind rivet retaining clip 800). Then, with the blind rivet 401 retained at the blind rivet retention tabs 212 at blind rivet retaining clip 800, the solar module frame 100, rail 402, and blind rivet retaining clip 800 can be coupled together by setting the blind rivet 401 retained at the blind rivet retention tabs 212 at the blind rivet retention clip 800 as described previously to form the rivet bulb against the clip base 202 to thereby couple the frame 100 to the rail 402 which rail 402 can itself be coupled to torque tube 14.

The blind rivet retaining clip 800 can exclude a mounting arm as described previously for other clip embodiments such that the clip base 202 of the blind rivet retaining clip 800 can be configured to sit at the first side 101 of the solar module frame 100 without a structure sitting below the opposite second side of the solar module frame 100. The blind rivet retaining clip 800 can exclude alignment tabs 220 as well such that the clip base 202 can move freely relative to the first side 101 of the solar module frame 100, including moving freely over the coupling slot 103 at that first side 101 of the solar module frame 100.

FIGS. 8B-8G illustrate a sequence for placing blind rivet 401 at blind rivet retaining clip 800 and then setting the blind rivet 401 at the blind rivet retaining clip 800 to form rivet bulb 406 against the blind rivet retaining clip 800. In some applications, the sequence at FIGS. 8B to 8G can be similar to, or the same as, the sequence(s) disclosed previously herein with respect to FIGS. 4 and/or 6 except that it is the blind rivet retaining clip 800 that is being used. As previously described, blind rivet 401 can be placed through the blind rivet aperture 205 at the blind rivet retaining clip 800 to cause one or both of the pair blind rivet retention tabs 212 to engage the blind rivet 401 (e.g., via the engagement end portion 213 at one or both of the blind rivet retention tabs 212) as the blind rivet 401 is inserted through the blind rivet aperture 205 to help retain the blind rivet 401, at the blind rivet retaining clip 800, prior to setting the blind rivet 401 at the blind rivet retaining clip 800. For instance, as the blind rivet 401 is inserted through the blind rivet aperture 205, one or both of the blind rivet retention tabs 212 can engage the blind rivet, for instance, at the engagement end portion 213 at one or both of the blind rivet retention tabs 212. In some cases, as the blind rivet 401 so engages one or both of the blind rivet retention tabs 212, one or both of the blind rivet retention tabs 212 can move from the stowed position to the blind rivet engagement position, such as, for instance, in direction 211 away from the clip base 202. One example of this, as applied to the blind rivet retaining clip 800, is illustrated at the exemplary sequence shown at FIGS. 8B-8E.

Then, with the blind rivet 401 retained at one or both of the blind rivet retention tab 212 at blind rivet retaining clip 800, for instance as shown at the example at FIG. 8F, the solar module frame 100, rail 402, and blind rivet retaining clip 800 can be axially aligned relative to one another and the blind rivet 401 can be set at the blind rivet retaining clip 800, such as shown at the example at FIG. 8G (e.g., which can cause one or both of the blind rivet retention tabs 212 to move from the blind rivet engagement position to the stowed position, such as, for instance, in a direction back toward the clip base 202). Axially aligning the solar module frame 100, rail 402, and blind rivet retaining clip 800 can include axially aligning blind rivet aperture 205 with each of coupling slot 410 at rail 402 and coupling slot 103 at solar module frame 100 such that blind rivet 401 can be inserted through each of the axially aligned blind rivet aperture 205, rail coupling slot 410, and frame coupling slot 103. The ability to move the blind rivet retaining clip 800 relative to each of the frame 100 and rail 402 while the blind rivet retaining clip 800 retains the blind rivet 401 prior to setting the blind rivet 401 at the blind rivet retaining clip 800 can allow for efficient such alignment followed by efficient coupling of the frame 101 to the rail 402 via setting the blind rivet 401 retained at the blind rivet retaining clip 800.

Various examples have been described. These and other examples are within the scope of the following claims.

What is claimed is:

1. A blind rivet retaining clip comprising:
a clip base that is configured to interface with a first side of a solar module frame;
a blind rivet aperture extending through the clip base;
a grounding tab extending out from a first side surface of the clip base; and
a blind rivet retention tab extending out from a second side surface of the clip base and adjacent to the blind rivet aperture, the second side surface opposite the first side surface,
wherein the blind rivet retention tab is configured to engage a blind rivet inserted through the blind rivet aperture, and
wherein the grounding tab is configured to enable an electrical grounding function at the solar module frame when the blind rivet is inserted through the blind rivet aperture and when the blind rivet is set at the blind rivet aperture.

2. The clip of claim 1, wherein the grounding tab is configured to penetrate an anodizing layer at the solar module frame to enable the electrical grounding function as a result of the blind rivet being set at the blind rivet aperture.

3. The clip of claim 1, wherein the blind rivet retention tab is configured to engage the blind rivet inserted through the blind rivet aperture at a location at the blind rivet above the second side surface of the clip base.

4. The clip of claim 3, wherein the blind rivet retention tab extends out from the second side surface of the clip base, to the location at the blind rivet above the second side surface of the clip base, at a skewed angle relative to the second side surface of the clip base.

5. The clip of claim 1, wherein the blind rivet retention tab is configured to move away from the second side surface of the clip base when the blind rivet retention tab engages the blind rivet as the blind rivet is inserted through the blind rivet aperture.

6. The clip of claim 5, wherein the blind rivet retention tab is configured to move toward the second side surface of the clip base when the blind rivet is set at the blind rivet aperture.

7. The clip of claim 6, wherein the clip base is a planar surface that is configured to provide a resistive force against the blind rivet to cause the blind rivet to from a blind rivet bulb against the planar surface and about the blind rivet aperture at the second side surface of the clip base when the blind rivet is set at the blind rivet aperture.

8. The clip of claim 6,
wherein the blind rivet retention tab is a first blind rivet retention tab,
wherein the clip further comprises: a second blind rivet retention tab extending out from the second side surface of the clip base and adjacent to the blind rivet aperture, the second blind rivet retention tab spaced apart from the first blind rivet retention tab about the second side surface of the clip base,
wherein the second blind rivet retention tab is configured to move away from the second side surface of the clip base when the second blind rivet retention tab engages the blind rivet as the blind rivet is inserted through the blind rivet aperture, and
wherein the second blind rivet retention tab is configured to move toward the second side surface of the clip base when the blind rivet is set at the blind rivet aperture.

9. The clip of claim 1, further comprising:
an alignment tab adjacent to the blind rivet aperture, the alignment tab configured to engage a coupling slot at the solar module frame.

10. The clip of claim 9, wherein the alignment tab extends out from the first side surface of the clip base in a direction away from the blind rivet aperture.

11. The clip of claim 1, further comprising:
a mounting arm integral with the clip base, the mounting arm spaced apart from the clip base to define a solar module receptacle between the clip base and a first mounting arm surface of the mounting arm, the mounting arm defining a second blind rivet aperture in axial alignment with the blind rivet aperture at the clip base.

12. The clip of claim 11, further comprising:
a rail alignment tab adjacent to the second blind rivet aperture and extending out from a second mounting arm surface of the mounting arm, the second mounting arm surface being opposite the first mounting arm surface, the rail alignment tab configured to engage a coupling slot at a rail component.

13. A method comprising the steps of:
placing a blind rivet at a blind rivet aperture at a blind rivet retaining clip such that a blind rivet retention tab of the blind rivet retaining clip engages the blind rivet, wherein the blind rivet retaining clip comprises: a clip base interfacing with a solar module frame, the blind rivet aperture extending through the clip base, a grounding tab extending out from a first side surface of the clip base to interface with the solar module frame, and the blind rivet retention tab extending out from a second, opposite side surface of the clip base and adjacent to the blind rivet aperture; and
setting the blind rivet at the blind rivet retaining clip to form a rivet bulb at the blind rivet against the second side surface of the clip base.

14. The method of claim 13, further comprising:
establishing an electrical grounding connection between the solar module frame and the grounding tab at the blind rivet retaining clip as a result of setting the blind rivet at the blind rivet retaining clip.

15. The method of claim 14, wherein setting the blind rivet at the blind rivet retaining clip to form the rivet bulb at the blind rivet against the second side surface of the clip base causes the grounding tab at the blind rivet retaining clip to penetrate an anodizing layer at the solar module frame to establish the electrical grounding connection between the solar module frame and the grounding tab.

16. The method of claim 13, further comprising:
when the blind rivet is placed at the blind rivet aperture at the blind rivet retaining clip such that the blind rivet retention tab engages the blind rivet and prior to setting the blind rivet, moving the solar module frame relative to a rail component with the blind rivet retention tab engaged at the blind rivet.

17. The method of claim 16,
wherein moving the solar module frame relative to the rail component with the blind rivet retention tab engaged at the blind rivet comprises causing an alignment tab, which is adjacent to the blind rivet aperture, at the blind rivet retaining clip to engage a coupling slot at the solar module frame, and
wherein when the alignment tab is engaged at the coupling slot at the solar module frame the blind rivet is set at the blind rivet retaining clip to form the rivet bulb at the blind rivet against the second side surface of the clip base.

18. The method of claim 13, wherein placing the blind rivet at the blind rivet aperture such that the blind rivet retention tab engages at the blind rivet comprises moving the blind rivet retention tab away from the second side surface of the clip base as the blind rivet is inserted through the blind rivet aperture.

19. The method of claim 18, wherein setting the blind rivet at the blind rivet retaining clip to form the rivet bulb at the blind rivet against the second side surface of the clip base comprises moving the blind rivet retention tab toward the second side surface of the clip base.

20. The method of claim 19, wherein setting the blind rivet at the blind rivet retaining clip to form the rivet bulb at the blind rivet against the second side surface of the clip base further comprises applying a blind rivet setting force in a first direction along a first setting axis to cause application of a resistive force, via a planar surface at the second side surface of the clip base, in second, opposite direction along the first setting axis against the blind rivet to cause the blind rivet to from the blind rivet bulb against the planar surface and about the blind rivet aperture at the second side surface of the clip base and to cause a mandrel to break off of the blind rivet.
